(19) United States
(12) Patent Application Publication
(10) Pub. No.: US 2026/0154994 A1
(43) Pub. Date: Jun. 4, 2026

(54) INFORMATION PROCESSING DEVICE

(71) Applicant: TOYOTA JIDOSHA KABUSHIKI KAISHA, Toyota-shi (JP)

(72) Inventors: Shingo SUGIMOTO, Nagoya-shi (JP); Yuma ITO, Chiryu-shi (JP); Shigeo OHNOGI, Aichi-gun (JP); Isao NISHIOKA, Tokyo (JP); Naoki UEDA, Nisshin-shi (JP)

(73) Assignee: TOYOTA JIDOSHA KABUSHIKI KAISHA, Toyota-shi (JP)

(21) Appl. No.: 19/377,006

(22) Filed: Nov. 2, 2025

(30) Foreign Application Priority Data
Nov. 29, 2024 (JP) 2024-209093

(51) Int. Cl. G07C 5/00; B60L 58/12; G07C 5/04; G07C 5/10; H01M 10/48

(52) U.S. Cl. CPC G07C 5/008; B60L 58/12; G07C 5/04; G07C 5/10; H01M 10/486; B60L 2240/545; H01M 2220/20

(57) ABSTRACT

An information processing device includes a communication unit that is capable of communicating with a vehicle, a controller, and a storage unit. The controller stores a plurality of pieces of content in the storage unit, acquires, in a case where a charging start condition of the vehicle is satisfied, a charging time of the vehicle predicted based on a charging condition of the vehicle, selects one or more pieces of the content from among the plurality of pieces of content based on the charging time, and provides the selected one or more pieces of the content to the vehicle via a LAN.

### CROSS-REFERENCE TO RELATED APPLICATION

This application claims priority to Japanese Patent Application No. 2024-209093 filed on Nov. 29, 2024. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

In the related art, a technique of providing content during battery charging of a vehicle is known. For example, Japanese Unexamined Patent Application Publication No. 2023-180740 (JP 2023-180740 A) discloses a technique of managing a state of a battery during charging of the vehicle and changing entertainment content to be provided based on a remaining charging time of the battery.

### SUMMARY

There is room for improvement in the technique of providing content during battery charging of the vehicle.

An object of the present disclosure that is made in view of such circumstances is to improve the technique of providing content during battery charging of the vehicle.

An information processing device according to an embodiment of the present disclosure includes
a communication unit communicable with a vehicle,
a controller, and
a storage unit.
The controller is configured to:
   store a plurality of pieces of content in the storage unit;
   acquire battery information including a battery remaining amount, a battery capacity, and a battery temperature of the vehicle;
   determine, in a case where a charging start condition of the vehicle is satisfied, a predicted charging time by inputting the battery information of the vehicle to a machine learning model trained using the battery information as a feature amount and a charging time as a correct answer label;
   decide one or more pieces of content from among the pieces of content based on the predicted charging time; and
   provide the decided one or more pieces of content to the vehicle via a LAN.

An information processing device according to an embodiment of the present disclosure includes
a communication unit communicable with a vehicle,
a controller, and
a storage unit.
The controller is configured to:
   store a plurality of pieces of content in the storage unit;
   acquire, in a case where a charging start condition of the vehicle is satisfied, a predicted
   charging time of the vehicle based on a charging condition of the vehicle;
decide one or more pieces of content from among the pieces of content based on the charging time; and
provide the decided one or more pieces of content to the vehicle via a LAN.

According to the embodiment of the present disclosure, it is possible to improve the technique of providing content during battery charging of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment of the present disclosure; and

FIG. 2 is a flowchart showing an operation of an information processing device according to the embodiment of the present disclosure.

### DETAILED DESCRIPTION OF EMBODIMENTS

An embodiment of the disclosure will be described below.

### Overview of Embodiment

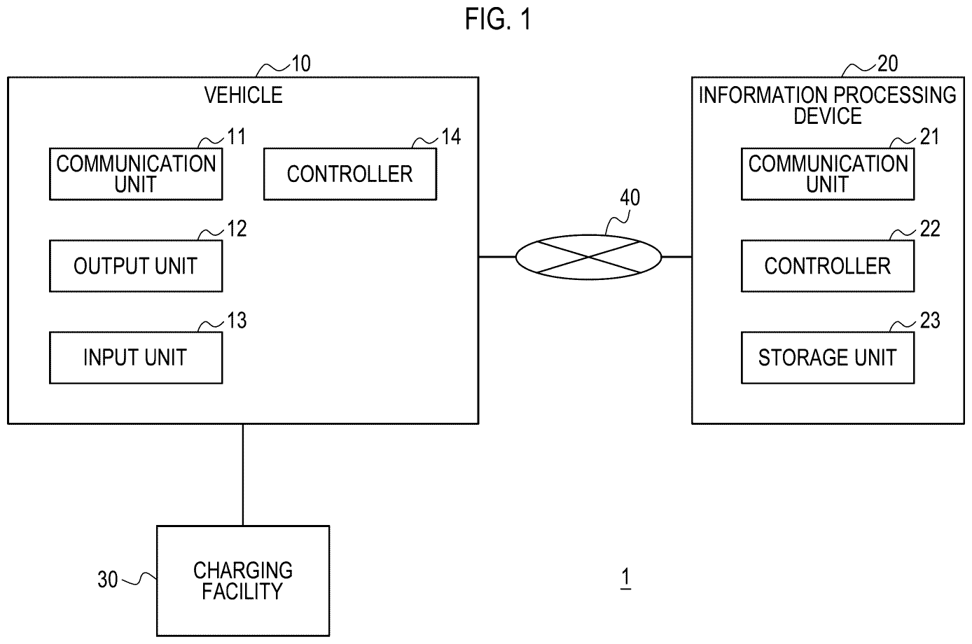

As shown in FIG. 1, an outline of a system 1 according to an embodiment of the present disclosure will be described. The system 1 includes a vehicle 10, an information processing device 20, and a charging facility 30. A user can charge the vehicle 10 by using the charging facility. While a charging start condition of the vehicle 10 is satisfied, the user can receive provision of content from the information processing device 20 via a network 40.

The vehicle 10 is, for example, an automobile, but the vehicle 10 is not limited thereto and may be any vehicle. The automobile is a battery electric vehicle (BEV), a plug-in hybrid electric vehicle (PHEV), a fuel cell electric vehicle (FCEV), or the like, but is not limited thereto. The number of vehicles 10 included in the system 1 may be randomly determined.

The information processing device 20 is one or a plurality of computers that are capable of communicating with each other, and is capable of communicating with the vehicle 10 via the network 40.

In a case where the vehicle 10 is an electrified vehicle such as a BEV or a PHEV, the charging facility 30 is configured to charge a battery of the vehicle 10. The charging facility 30 may include a converter, an inverter, or the like that controls a current or a voltage to be supplied to the battery of the vehicle 10. The charging facility 30 may include a processor or a dedicated circuit that controls charging of the battery and the entire charging facility. The charging facility 30 may include a power supply cable or a power supply connector that is connected to the vehicle 10. The charging facility 30 may include a device configured to supply power to the vehicle 10 in a noncontact manner. The charging facility 30 may be connected to a power grid and may charge the battery of the vehicle 10 by using power supplied from the power grid. The charging facility 30 may include a power source such as a battery or a generator and may charge the battery of the vehicle 10 by using power supplied from the power source.

First, an outline of the present embodiment will be described, and details will be described later. The information processing device 20 includes a communication unit 21 that is capable of communicating with the vehicle 10, a controller 22, and a storage unit 23. The controller 22 stores a plurality of pieces of content in the storage unit 23. In a case where the charging start condition of the vehicle 10 is satisfied, the controller 22 acquires a charging time of the vehicle 10 predicted based on a charging condition of the vehicle 10. The controller 22 selects one or more pieces of the content from among the plurality of pieces of content based on the charging time, and provides the selected one or more pieces of the content to the vehicle 10 via a LAN.

As described above, according to the present embodiment, for example, in a case where the charging start condition of the vehicle 10 is satisfied by using the LAN constructed at a charging spot, it is possible to provide the content in a high-speed, stable, and high-security environment. For example, it is possible to update map data of an electronic control unit (ECU) and a car navigation system mounted on the vehicle 10 during power supply. In addition, since the content to be provided to the user is selected based on the charging time, the user can spend a waiting time for charging meaningfully. Therefore, from the viewpoint of improving the user experience, the technique of providing content during battery charging of the vehicle 10 is improved.

Next, each configuration of the system 1 will be described in detail.

### Configuration of Vehicle 10

As shown in FIG. 1, the vehicle 10 includes a communication unit 11, an output unit 12, an input unit 13, and a controller 14.

The communication unit 11 includes one or more communication interfaces connected to the network 40. The communication interface corresponds to, for example, a mobile communication standard, such as a 4th generation (4G) or a 5th generation (5G), but is not limited thereto. In the present embodiment, the vehicle 10 communicates with the information processing device 20 via the communication unit 11 and the network 40.

The output unit 12 includes one or more output devices that output information. The output device is, for example, a display or a speaker, but is not limited thereto. Alternatively, the output unit 12 may include an interface for connecting an external output device.

The input unit 13 includes one or more input devices that detect a user input. The input device is, for example, a physical key, a capacitive key, a pointing device such as a mouse, a touch screen that is integrally provided with a display of the output unit 12, a microphone that receives a voice input, or the like, but is not limited thereto. Alternatively, the input unit 13 may include an input interface that detects a user input via an external input device.

The controller 14 includes one or more processors, one or more programmable circuits, one or more dedicated circuits, or a combination thereof. The processor is, for example, a general-purpose processor, such as a central processing unit (CPU) or a graphics processing unit (GPU), or a dedicated processor specialized for specific processing, but is not limited thereto. The programmable circuit is, for example, a field-programmable gate array (FPGA), but is not limited thereto. The dedicated circuit is, for example, an application specific integrated circuit (ASIC), but is not limited thereto. The controller 14 controls the operation of the vehicle 10 as a whole.

### Configuration of Information Processing Device 20

As shown in FIG. 1, the information processing device 20 includes the communication unit 21, the controller 22, and the storage unit 23.

The communication unit 21 includes one or more communication interfaces connected to the network 40. The communication interface corresponds to, for example, a mobile communication standard, such as a 4th generation (4G) or a 5th generation (5G), but is not limited thereto. In the present embodiment, the information processing device 20 communicates with the vehicle 10 via the communication unit 21 and the network 40.

The controller 22 includes one or more processors, one or more programmable circuits, one or more dedicated circuits, or a combination thereof. The processor is, for example, a general-purpose processor, such as a central processing unit (CPU) or a graphics processing unit (GPU), or a dedicated processor specialized for specific processing, but is not limited thereto. The programmable circuit is, for example, a field-programmable gate array (FPGA), but is not limited thereto. The dedicated circuit is, for example, an application specific integrated circuit (ASIC), but is not limited thereto. The controller 22 controls the operation of the information processing device 20 as a whole.

The storage unit 23 includes one or more memories. The memory is, for example, a semiconductor memory, a magnetic memory, an optical memory, or the like, but is not limited thereto. Each memory included in the storage unit 23 may function, for example, as a main storage device, an auxiliary storage device, or a cache memory. The storage unit 23 stores any information used for the operation of the information processing device 20. For example, the storage unit 23 may store a system program, an application program, or embedded software. In addition, the storage unit 23 stores a plurality of pieces of content to be provided to the vehicle 10.

### Operation Procedure of Information Processing Device 20

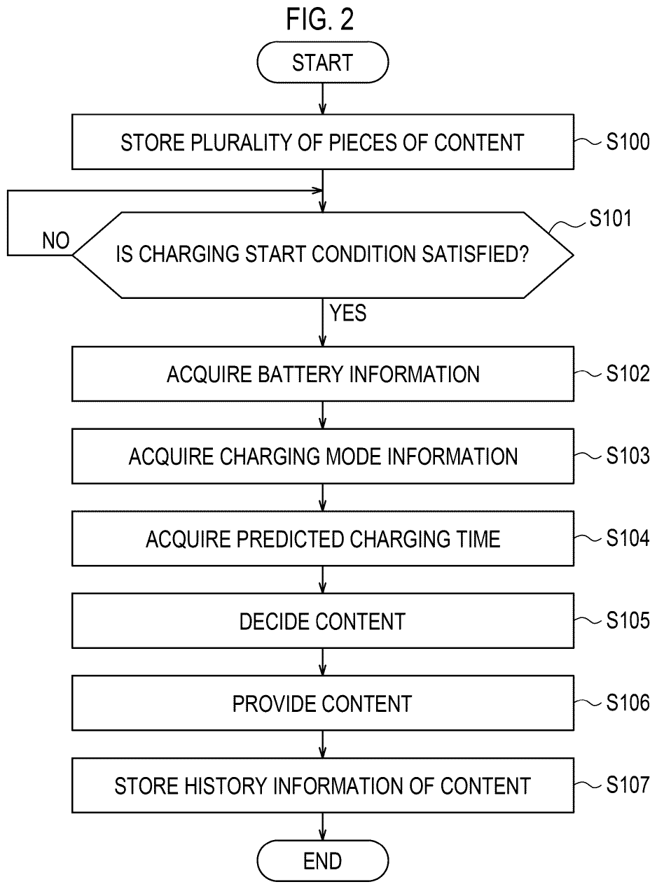

As shown in FIG. 2, an operation of the information processing device 20 according to the present embodiment will be described.

S100: The controller 22 of the information processing device 20 stores the plurality of pieces of content in the storage unit 23.

The content may include any electronic content such as a video, music, a game, an e-book, a podcast, map data of a navigation system, over the air (OTA) data, advertising data, or interactive content. The information processing device 20 may receive the content via, for example, the communication unit 21 and the network 40, or may acquire the content by using any method.

S101: The controller 22 acquires information indicating whether the charging start condition of the vehicle 10 is satisfied.

As the charging start condition, the vehicle or the charging facility may detect that a charging cable is connected to the vehicle by using a sensor that physically or electrically detects that the charging cable is connected to the vehicle. In addition, the vehicle or the charging facility may detect that the vehicle has entered a chargeable area by using a sensor that electromagnetically detects that the vehicle has entered the chargeable area. The controller 22 may receive the information indicating whether the charging start condition is satisfied from the vehicle 10 or the charging facility 30 connected to the network 40, via the network 40. In addition, the charging start condition may be determined by using any method without being limited thereto. In a case where the charging start condition of the vehicle 10 is satisfied, S102 is executed.

S102: The controller 22 acquires battery information including a battery remaining amount, a battery capacity, and a battery temperature of the vehicle 10.

The battery information includes the battery remaining amount, the battery capacity, and the battery temperature, but is not limited thereto and may include any information. The controller 22 may acquire the battery information from the vehicle 10 or the charging facility 30 connected to the network 40 via the communication unit 21 and the network 40.

S103: The controller 22 acquires information on a charging mode selected by the user from among a plurality of charging modes.

The charging mode includes, for example, a normal charging mode, a fast charging mode, or the like, but is not limited thereto and may include any mode. Any settings such as a charging current and a fee to be paid by the user may be different between the normal charging mode and the fast charging mode.

S104: The controller 22 acquires the charging time of the vehicle 10 predicted based on the charging condition of the vehicle 10.

The charging condition includes, for example, information such as a charging power amount, a charging current, and full charging, but is not limited thereto and may include any information. As the charging current, a current value corresponding to the charging mode described in S103 may be used.

The information processing device 20 may store a machine learning model in the storage unit 23. In such a case, the predicted charging time may be determined by inputting the battery information of the vehicle 10 to the machine learning model trained using the battery information described in S102 as a feature amount and the charging time as a correct answer label. As a result, it is possible to determine the charging time with higher accuracy.

S105: The controller 22 selects one or more pieces of the content from among the plurality of pieces of content stored in the storage unit 23 based on the charging time.

In a case where a playback time of the video or the music is determined, the content may be selected such that the playback time is shorter than the charging time. In addition, in a case where there is no time constraint, such as a game, the content may be selected in a case where the charging time is longer than a predetermined time. In addition, in a case of data such as map data of a navigation system or OTA data, the content may be selected such that a download time of the data is shorter than the charging time. As a result, for example, even in a connected car whose communication contract is expired, software update or the like can be performed at a charging spot.

In addition, as will be described in detail in S107, history information of the one or more pieces of content provided to the vehicle 10 may be further stored in the storage unit 23. In such a case, the one or more pieces of content to be provided to the vehicle 10 may be selected based on a first condition that the content is one or more pieces of content included in or related to the history information. As a result, for example, even in a case where the charging is completed before the content provision is completed, the content can be provided from a continuation of the content next time. In addition, it is possible to select content related to the content provided to the user.

In addition, the one or more pieces of content to be provided to the vehicle 10 may be selected based on a second condition that the charging mode selected by the user is a predetermined charging mode. For example, the predetermined condition may be a fast charging mode. In such a case, content having a high additional value is provided for a fee to the user who has selected the normal charging mode. On the other hand, the content having a high additional value may be provided for free to the user who has selected the fast charging mode. As a result, it is possible to prompt the user to select the fast charging mode with a short charging time, and increase the number of users of the charging facility 30.

S106: The controller 22 provides the selected one or more pieces of the content to the vehicle 10 via the LAN.

By providing the content via the LAN constructed at the charging spot, the user can receive the content in a high-speed, stable, and high-security environment without paying a communication fee.

S107: The controller 22 further stores history information of the one or more pieces of content provided to the vehicle 10 in the storage unit 23.

The history information includes, for example, a date on which the content is provided to the vehicle 10, a title of the content, a time required for playing the content, a time at which the content is played, a data capacity of the content, a data capacity of transmitted content, a genre of the content, information on related content, and the like. The history information is not limited thereto and may include any information.

Although the disclosure has been described with reference to drawings and examples, it should be noted that various variations and modifications may be made by those skilled in the art based on the disclosure. Therefore, it should be noted that the variations and modifications fall within the scope of the disclosure. For example, functions included in each component or each step can be rearranged so as not to be logically inconsistent, and multiple components or steps can be combined together or separated.

For example, in the above-described embodiment, an embodiment is also possible in which the configuration and operation of the information processing device 20 are distributed to a plurality of computers that can communicate with each other. For example, an embodiment can also be adopted in which some or all of components of the information processing device 20 are provided in the vehicle 10 or the charging facility 30.

In the above-described embodiment, the vehicle 10 may further include an imaging unit and a storage unit. The vehicle 10 may store a moving image captured by the imaging unit in the storage unit. In addition, the vehicle 10 may store information on a driving area, a driving distance, and the like in the storage unit. In such a case, in S105, the controller 22 may select one or more pieces of driving history information from among a plurality of pieces of driving history information stored in the vehicle 10 based on the charging time. In addition, in S106, the controller 22 may receive the selected one or more pieces of the driving history information from the vehicle 10 via the LAN. The driving history information refers to, for example, information such as a driving distance of the vehicle 10, a driving area, and a moving image captured by a drive recorder, but is not limited thereto and may include any information. As a result, it is possible to collect information necessary for achieving automatic driving technology or the like. In addition, the user does not need to pay a communication fee because the LAN is used.

In addition, in the above-described embodiment, the controller 22 may select one or more pieces of the content in S105 and provide a list of the one or more pieces of content to the vehicle 10. In such a case, the vehicle 10 may display the list of one or more pieces of the content that can be selected by the user on the output unit 12. In addition, the information processing device 20 may provide the content selected by the user to the vehicle 10.

What is claimed is:

1. An information processing device comprising:
a communication unit communicable with a vehicle;
a controller; and
a storage unit,
wherein the controller is configured to:
store a plurality of pieces of content in the storage unit;
acquire battery information including a battery remaining amount, a battery capacity, and a battery temperature of the vehicle;
determine, in a case where a charging start condition of the vehicle is satisfied, a predicted charging time by inputting the battery information of the vehicle to a machine learning model trained using the battery information as a feature amount and a charging time as a correct answer label;
decide one or more pieces of content from among the pieces of content based on the predicted charging time; and
provide the decided one or more pieces of content to the vehicle via a LAN.

2. An information processing device comprising:
a communication unit communicable with a vehicle;
a controller; and
a storage unit,
wherein the controller is configured to:
store a plurality of pieces of content in the storage unit;
acquire, in a case where a charging start condition of the vehicle is satisfied, a predicted charging time of the vehicle based on a charging condition of the vehicle;
decide one or more pieces of content from among the pieces of content based on the charging time; and
provide the decided one or more pieces of content to the vehicle via a LAN.

3. The information processing device according to claim 2, wherein the controller is configured to:
further stores history information of the one or more pieces of content provided to the vehicle in the storage unit; and
decide the one or more pieces of content to be provided to the vehicle based on a first condition that the one or more pieces of content are included in or related to the history information.

4. The information processing device according to claim 2, wherein the controller is configured to:
acquire information on a charging mode selected by a user from among a plurality of charging modes; and
decide the one or more pieces of content to be provided to the vehicle based on a second condition that the selected charging mode is a predetermined charging mode.

5. The information processing device according to claim 2, wherein the controller is configured to:
decide one or more pieces of traveling history information from among a plurality of pieces of traveling history information stored in the vehicle, based on the charging time; and
receive the decided one or more pieces of traveling history information from the vehicle via the LAN.
